(19) United States
(12) Patent Application Publication
(10) Pub. No.: US 2026/0280178 A1
(43) Pub. Date: Sep. 17, 2026

(54) TERMINAL MODULE AND CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tetsuya MIYAMURA, Mie (JP)

(21) Appl. No.: 19/168,813

(22) PCT Filed: Mar. 22, 2024
(86) PCT No.: PCT/JP2024/011374

§ 371 Date: Sep. 25, 2025

(30) Foreign Application Priority Data
Apr. 3, 2023 (JP) 2023-059924

(51) Int. Cl. H01R 13/436; H01R 13/506

(52) U.S. Cl. CPC H01R 13/4367; H01R 13/506

(57) ABSTRACT

The purpose of the present invention is to improve the strength of a terminal module. Provided is a terminal module that houses a terminal, the terminal module comprising: a terminal-equipped electric wire including an electric wire and a terminal attached to the end of the electric wire; and a terminal holder which has a cavity for housing the terminal, the electric wire extending from an opening of the cavity. The terminal holder includes a first component and a second component that forms the cavity by being combined with the first component. The first component has a wall part partitioning the cavity. The second component has a lid part facing the tip-end of the wall part. The lid part has a wall-positioning surface for positioning the wall part in the thickness direction thereof.

### TECHNICAL FIELD

The present disclosure relates to a terminal module and a connector.

### BACKGROUND

Patent Document 1 discloses a terminal unit provided with a dielectric made of synthetic resin and a pair of inner conductors. The dielectric is configured by assembling a holding member constituting a half and a cover member constituting a half. The holding member is provided with a bottom wall portion and a pair of side wall portions rising upward from both left and right side edges of the bottom wall portion, and a separation wall portion rising upward is formed in a lateral center of the bottom wall portion. A pair of left and right accommodation chambers defined by the separation wall portion and the pair of side wall portions are formed inside the holding member. The inner conductor is accommodated in each accommodation chamber. A wire fixed to the inner conductor extends out from a rear opening of the accommodation chamber.

### PRIOR ART DOCUMENT

### Patent Document

Patent Document 1: JP 2018-147558 A

### SUMMARY OF THE INVENTION

### Problems to be Solved

It is desired to improve the strength of a terminal module in preparation for a case where the wire extending out from the terminal module is pulled or the like.

Accordingly, the present disclosure aims to improve the strength of a terminal module.

### Means to Solve the Problem

The present disclosure is directed to a terminal module for accommodating a terminal, the terminal module being provided with a terminal-equipped wire including a wire and the terminal mounted on an end part of the wire, and a terminal holder including a cavity for holding the terminal, the wire extending out from an opening of the cavity, the terminal holder including a first component and a second component forming the cavity by being united with the first component, the first component including a wall portion defining the cavity and the second component including a lid portion facing a tip part of the wall portion, and the lid portion having a wall positioning surface for positioning the wall portion in a thickness direction of the wall portion.

### Effect of the Invention

According to the present disclosure, the strength of a terminal module is improved.

### BRIEF DESCRIPTION OF THE DRAWINGS

FIG. 1 is a perspective view showing a connector according to an embodiment.

FIG. 2 is a perspective view showing the connector.

FIG. 3 is an exploded perspective view showing the connector.

FIG. 4 is an exploded perspective view showing the connector.

FIG. 5 is a section along V-V of FIG. 1.

FIG. 6 is an exploded perspective view showing a terminal module.

FIG. 7 is an exploded perspective view showing the terminal module.

FIG. 8 is a perspective view partly in section of a housing.

FIG. 9 is a perspective view partly in section of the housing.

FIG. 10 is a section along X-X of FIG. 2.

FIG. 11 is a section along XI-XI of FIG. 3.

FIG. 12 is a section of the terminal module.

FIG. 13 is a section of the terminal module.

FIG. 14 is a section along XIV-XIV of FIG. 3.

FIG. 15 is a perspective view showing a connector different from the connector.

FIG. 16 is an exploded perspective view showing the connector.

FIG. 17 is a section along XVII-XVII of FIG. 15.

### DETAILED DESCRIPTION TO EXECUTE THE INVENTION

### Description of Embodiments of Present Disclosure

First, embodiments of the present disclosure are listed and described.

The terminal module of the present disclosure is as follows.

(1) The terminal module of the present disclosure is for accommodating a terminal and provided with a terminal-equipped wire including a wire and the terminal mounted on an end part of the wire, and a terminal holder including a cavity for holding the terminal, the wire extending out from an opening of the cavity, the terminal holder including a first component and a second component forming the cavity by being united with the first component, the first component including a wall portion defining the cavity and the second component including a lid portion facing a tip part of the wall portion, and the lid portion having a wall positioning surface for positioning the wall portion in a thickness direction of the wall portion.

If the wire extending out from the cavity is pressed against the wall portion by being pulled, a force for pushing the wall portion in the thickness direction thereof is applied to the wall portion. According to the terminal module of the present disclosure, the force for pushing the wall portion in the thickness direction is received by the wall positioning surface. Thus, the wall portion is hardly deformed and the strength of the terminal module is further improved.

(2) In the terminal module of (1), the wall positioning surface may be formed at a position for positioning an end part of the wall portion on a side where the wire extends out.

The wall portion is easily pushed by the wire on the side where the wire extends out. Thus, if the wall positioning surface is formed at the position for positioning the end part of the wall portion on the side where the wire extends out, the pushing force by the wire can be effectively received.

(3) In the terminal module of (1) or (2), the lid portion may include a wall positioning groove, a tip of the wall portion being fit into the wall positioning groove, and an inner surface of the wall positioning groove may be the wall positioning surface.

By fitting the tip of the wall portion into the wall positioning groove in this way, the wall portion is positioned in the thickness direction thereof.

(4) In the terminal module of (3), a wall positioning protrusion may be formed on an end side closer to the side where the wire extends out than a center in an extension direction of the wall portion, out of the tip of the wall portion, and the wall positioning protrusion may be fit in the wall positioning groove.

By fitting the wall positioning protrusion into the wall positioning groove in this way, a part of the wall portion on the side where the wire extends out is effectively positioned.

(5) In the terminal module of (4), the lid portion may have a surface facing the tip of the wall portion and planarly spreading in the thickness direction of the wall portion on a side opposite to the wall positioning protrusion in an extension direction of the wire.

In this case, even if the wall portion is deformed in a width direction, this deformation hardly affects a part of the lid portion on the opposite side in the extension direction of the wire. In this way, an external force is hardly applied to the tip part of the terminal.

(6) In the terminal module of (5), the terminal may include a terminal connecting portion and a wire connecting portion to be connected to the wire, and the wall positioning protrusion may be located closer to an extension direction side of the wire than the terminal connecting portion.

In this way, the wall portion can be positioned further on the extension direction side of the wire than the terminal connecting portion, wherefore an external force is hardly applied to the tip part of the terminal.

(7) In the terminal module of any one of (1) to (6), the wall portion may include a thickening portion projecting into the cavity on an edge on an extension direction side of the wire, and the wall positioning surface may position the thickening portion in the thickness direction of the wall portion.

A force given when the wire is pulled is thought to more strongly act on an edge part of the wall portion on the extension direction side of the wire. If the thickening portion located on the edge of the wall portion on the extension direction side of the wire is positioned by the wall positioning surface, this force is effectively received.

(8) In the terminal module of any one of (1) to (7), the wall portion may include a pair of side walls and a partition wall located between the pair of side walls, and the wall positioning surface may include a pair of side wall positioning surfaces for positioning each of the pair of side walls in a thickness direction of each side wall and a partition wall positioning surface for positioning the partition wall in a thickness direction of the partition wall.

A plurality of the cavities are formed by the pair of side walls and the partition wall. Regardless of which of the wires extending out from the plurality of cavities is pulled, the pair of side walls and the partition wall can be positioned to withstand this pulling force.

(9) In the terminal module of any one of (1) to (8), the terminal holder may further include a base holder having a base wall portion, a base cavity defined by the base wall portion may be formed by overlapping the first component on the base holder, and an exit opening edge part for the wire, out of the cavity, may be located at an outer side of an exit opening edge part for the wire, out of the base cavity.

In this case, the exit opening edge part for the wire, out of the cavity, is located at the outer side of the exit opening edge part for the wire, out of the base cavity. Thus, there is a possibility that the wire extending out from the cavity is more easily pulled with a strong force. By positioning the wall portion defining the cavity, a wire pulling force can be effectively received.

(10) In the terminal module of (9), the first component may have a base wall positioning surface for positioning the base wall portion in a thickness direction of the base wall portion.

In this way, the base wall portion defining the base cavity can also be positioned.

Further, a connector of the present disclosure is as follows.

(11) The connector is provided with the terminal module of any one of (1) to (10) and a housing including a holder holding portion for holding the terminal holder and a wire guiding portion for guiding the wire extending out from the holder holding portion.

According to this connector, even if a force is applied to the wall portion by pulling the wire when the terminal module is mounted into the housing, this force is effectively received by the wall positioning surface.

### Details of Embodiment of Present Disclosure

Specific examples of a terminal module and a connector of the present disclosure are described below with reference to the drawings. Note that the present disclosure is not limited to these illustrations, but is represented by claims and intended to include all changes in the scope of claims and in the meaning and scope of equivalents.

### Embodiment

Hereinafter, a terminal module and a connector according to an embodiment are described.

### Overall Structure

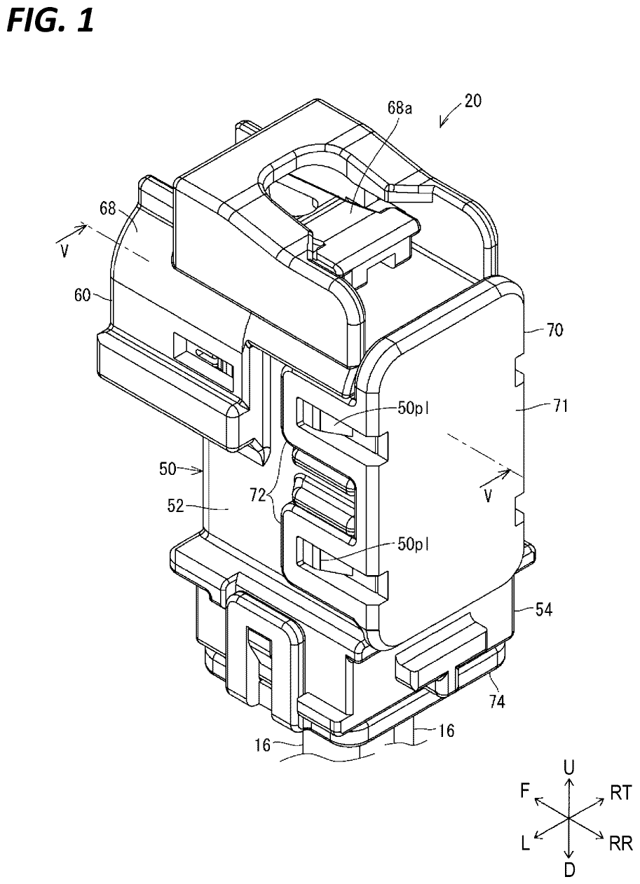

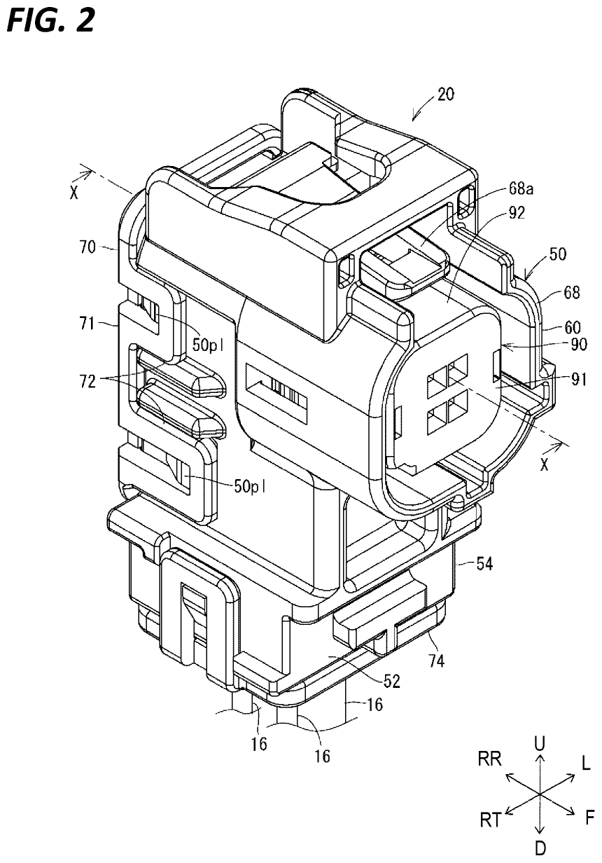

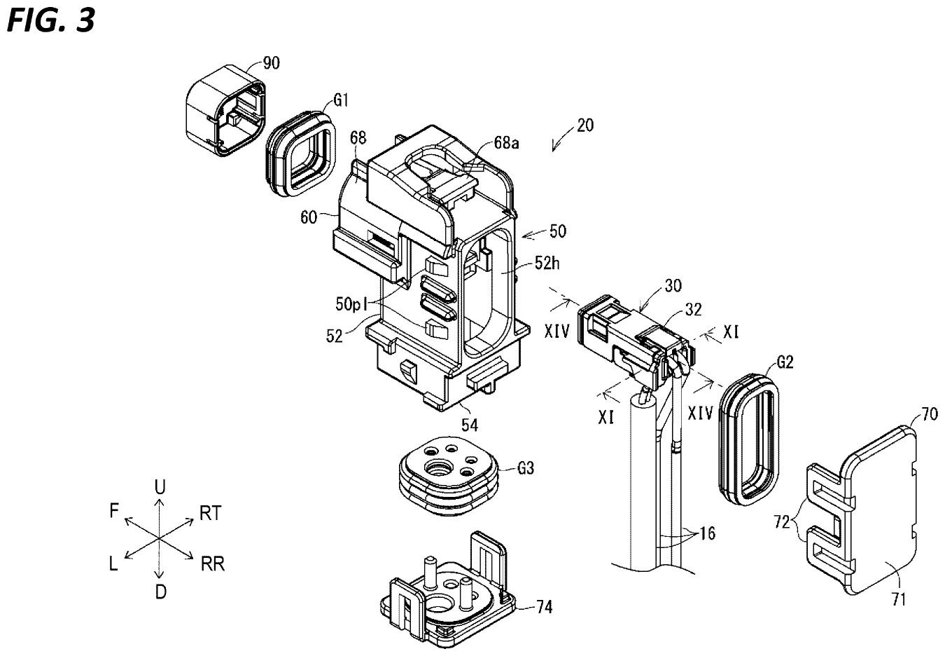

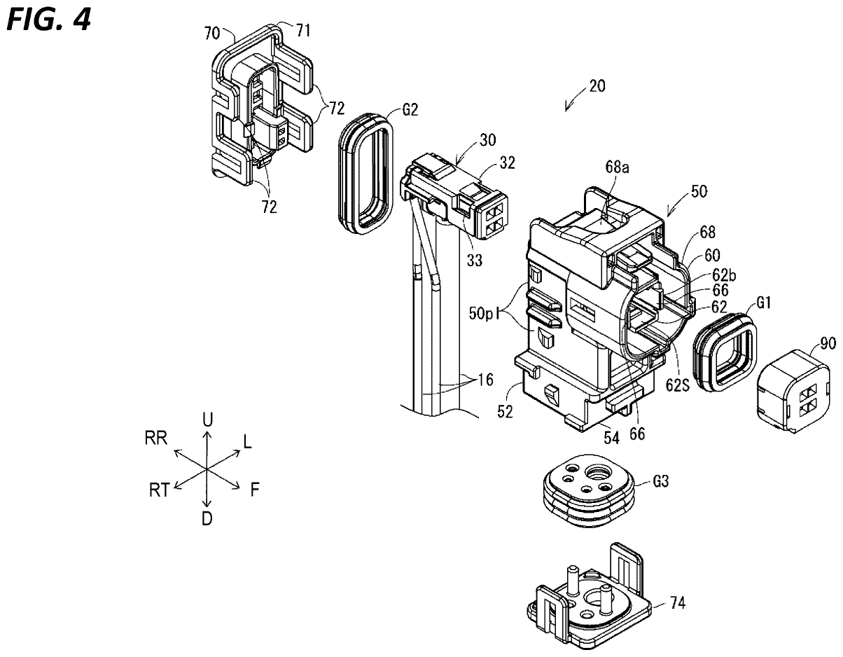

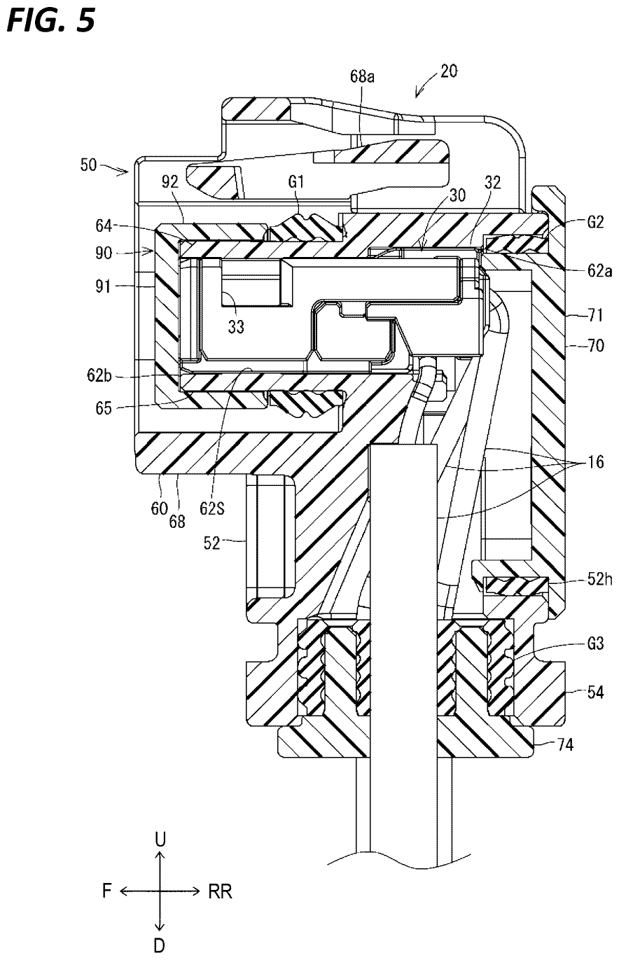

An overall structure of the connector is described. FIGS. 1 and 2 are perspective views showing a connector 20. FIGS. 3 and 4 are exploded perspective views showing the connector 20. FIG. 5 is a section along V-V of FIG. 1.

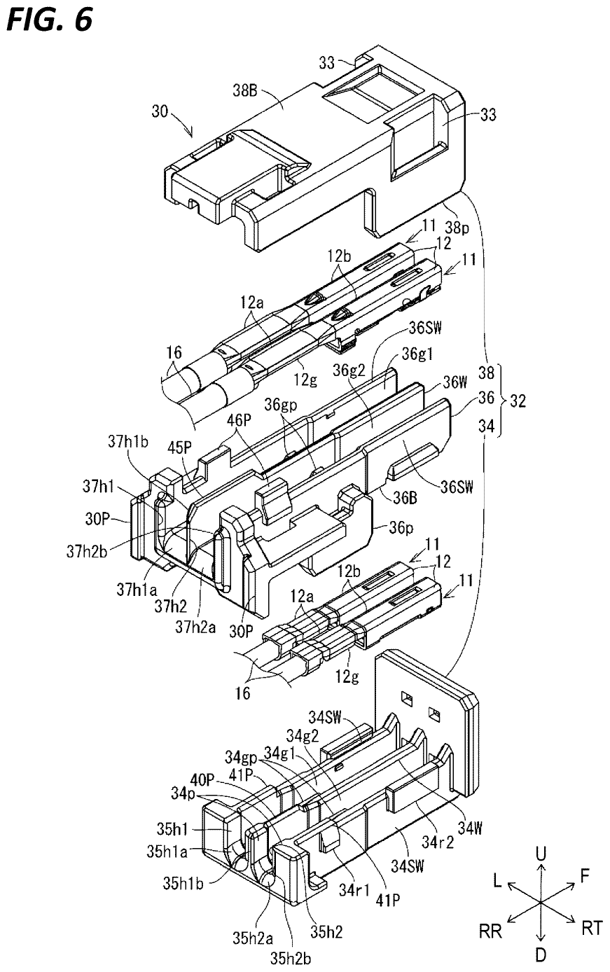

The connector 20 is a connector for holding terminals 12 via a terminal holder 32. The terminals 12 and the terminal holder 32 are described later with reference to FIG. 6 and the like. By connecting a mating connector to this connector 20, mating terminals of the mating connector are connected to the terminals 12.

The connector 20 is provided with terminal-equipped wires 11, the terminal holder 32 and a housing 50.

The terminal-equipped wire 11 includes a wire 16 and the terminal 12 mounted on an end part of the wire 16.

The terminals 12 are accommodated in the terminal holder 32. The terminal module 30 is constituted by the terminals 12 and the terminal holder 32 for accommodating the terminals 12. The wires 16 extend outward from the terminal holder 32. The terminals 12 are mounted into the housing 50 while being mounted in the terminal module 30.

The housing 50 holds the terminals 12 via the terminal holder 32. The housing 50 includes a holder holding portion 60 and a wire guiding portion 52. The terminal holder 32 is accommodated into the holder holding portion 60. The wire guiding portion 52 is integrally connected to the holder holding portion 60, and guides the wires 16 extending out from the holder holding portion 60. An extension direction of the wires 16 from the connector 20 is guided by the wire guiding portion 52.

Note that a retainer 90 is mounted into the holder holding portion 60. The terminal module 30 is held not to come out from the housing 50 by the retainer 90. In this embodiment, the retainer 90 is mounted into the housing 50 from a side opposite to a pull-out direction of the wires 16 from the terminal module 30. Such a retainer 90 may be called a front retainer.

The mating connector is connected to this connector 20 from the side opposite to the pull-out direction of the wires 16 from the terminal module 30. In the following description, for the sake of convenience, a side where the mating connector is connected may be referred to as a front side and an opposite side thereof may be referred to as a rear side. Further, a lock piece 68a for maintaining a connected state to the mating connector is located in the housing 50. For the sake of convenience, a side where the lock piece 68a is located with respect to the housing 50 may be referred to as an upper side and an opposite side thereof may be referred to as a lower side. Further, left and right sides may be referred to based on these front, rear, upper and lower sides.

The configuration of each component is described.

### Concerning Terminal Module

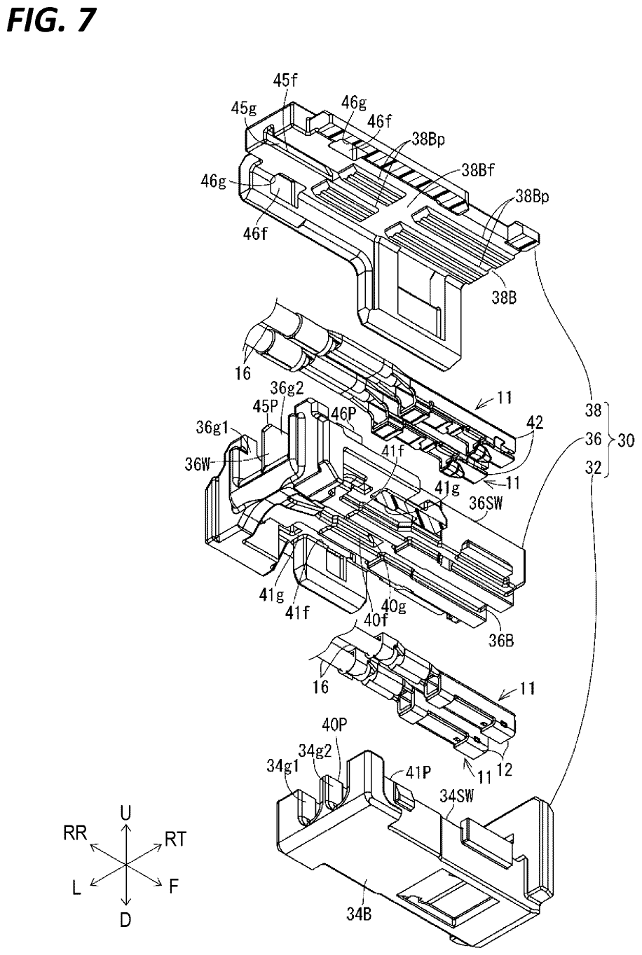

FIGS. 6 and 7 are exploded perspective views showing the terminal module 30. Note that side walls 34SW, 36SW on one side are not shown in FIG. 7. As shown in FIGS. 3 to 7, the terminal module 30 includes the terminals 12 and the terminal holder 32 for holding the terminals 12. The terminal 12 is a component formed, such as by press-working a metal plate, and includes a wire connecting portion 12a and a terminal connecting portion 12b. The wire connecting portion 12a and the terminal connecting portion 12b are, for example, linearly connected. The wire connecting portion 12a in one end part of the terminal 12 is connected to the end part of the wire 16 by crimping or the like. The terminal connecting portion 12b is, for example, formed into a tubular shape, and a pin-like or tab-like male connecting portion of the mating terminal is inserted and connected to the terminal connecting portion 12b.

In this embodiment, the terminal module 30 includes a plurality of the terminals 12. More specifically, the terminal module 30 includes four terminals 12. The four terminals 12 are so arranged that two terminals 12 are laterally arranged in each of two stages in a vertical direction. A plurality of the wires 16 extend out from the rear end of the terminal module 30. The number of the terminals 12 to be held by the terminal module 30 is arbitrary and the terminal module 30 may include only one, two or more terminals.

The terminal holder 32 is a resin component including cavities 34g1, 34g2, 36g1 and 36g2 for holding the terminals 12. The terminal holder 32 holds the plurality of terminals 12 in a predetermined array while insulating the terminals 12 from each other. The terminal holder 32 is held in the housing 50 with the plurality of terminals 12 held by the terminal holder 32. In this way, the plurality of terminals 12 can be easily held in a predetermined array state in the housing 50. The wires 16 connected to the terminals 12 extend out from rear openings of the cavities 34g1, 34g2, 36g1 and 36g2.

More specifically, the terminal holder 32 includes a base holder 34, an intermediate holder 36 and a cover holder 38.

The base holder 34 is formed with a plurality of (here, two) cavities 34g1, 34g2. The cavities 34g1, 34g2 are arranged in parallel and open on upper and rear sides. A front wall 34FW stands on the front edge of the base holder 34. The terminals 12 are arranged into the cavities 34g1, 34g2 through upper and rear openings of the cavities 34g1, 34g2. The cavity 34g1 is an example of a first cavity, and the cavity 34g2 is an example of a second cavity. The base holder 34 may be formed with more cavities.

More specifically, the base holder 34 includes a bottom portion 34B, a partition wall 34W and a pair of side walls 34SW. The partition wall 34W and the pair of side walls 34SW are arranged at intervals in a width direction of the bottom portion 34B. The first cavity 34g1 and the second cavity 34g2 defined by the partition wall 34W and the pair of side walls 34SW are formed on the bottom portion 34B. The partition wall 34B is a wall partitioning between the first and second cavities 34g1, 34g2. The pair of side walls 34SW are walls defining both outer sides of the cavities 34g1, 34g2.

The partition wall 34W and the pair of side walls 34SW are examples of base wall portions formed in the base holder 34. Further, the cavities 34g1, 34g2 are examples of base cavities defined and formed by the partition wall 34W and the pair of side walls 34SW by overlapping the base holder 34 and the intermediate holder 36. The partition wall 34W and the pair of side walls 34SW may be grasped as examples of wall portions defining the cavities 34g1, 34g2.

A positioning protrusion 34gp projects on a bottom part of the cavity 34g1, 34g2. The terminal 12 includes a recess 12g recessed between a coating crimping portion to be crimped to a coating of the wire, out of the wire connecting portion 12a, and the terminal connecting portion 12b. By fitting the positioning protrusion 34gp into the recess 12g of the terminal 12, the terminal 12 is positioned in the positioning protrusion 34gp.

The intermediate holder 36 is a component spreading to such an extent as to be able to close the upper openings of the plurality of cavities 34g1, 34g2. The intermediate holder 36 includes locking pieces 36p lockable to locking protrusions 34r1 of the base holder 34.

With the upper openings of the plurality of cavities 34g1, 34g2 closed by the intermediate holder 36, the locking pieces 36p are locked to the locking protrusions 34r1 on both sides of the base holder 34, whereby the intermediate holder 36 is held in a state overlapped on the base holder 34. In this state, the terminals 12 in the cavities 34g1, 34g2 are restricted from moving upward, and the state where the positioning protrusions 34gp are fit in the recesses 12g is maintained.

The intermediate holder 36 includes a plurality of (here, two) cavities 36g1, 36g2 located on a side opposite to the base holder 34. The cavities 36g1, 36g2 are arranged in parallel and open on upper and rear sides. With the intermediate holder 36 united with the base holder 34, the front wall 34FW of the base holder 34 is located forward of front openings of the cavities 36g1, 36g2. The terminals 12 are arranged into the cavities 36g1, 36g2 through upper and rear openings of the cavities 36g1, 36g2.

The cavity 36g1 is an example of the first cavity, and the cavity 36g2 is an example of the second cavity. The base holder 34 may be formed with more cavities.

The intermediate holder 36 includes a plate portion 36B, a partition wall 36W and a pair of side walls 36SW.

The plate portion 36B is a plate-like part arranged to face tip parts of the partition wall 34W and the pair of side walls 34SW and configured to close the upper openings of the cavities 34g1, 34g2. By uniting the plate portion 36B with the base holder 34, the cavities 34g1, 34g2 surrounded on four surrounding sides are formed.

The base holder 34 may be grasped as a first component including a wall portion and the intermediate holder 36 may be grasped as a second component including the plate portion 36B as a lid portion.

The plate portion 36B of the intermediate holder 36 has partition wall positioning surfaces 40f for positioning the partition wall 34W in a thickness direction. The plate portion 36B has side wall positioning surfaces 41f for respectively positioning the pair of side walls 34SW in the thickness direction. The partition wall positioning surfaces 40f and the side wall positioning surfaces 41f are examples of a wall positioning surface and examples of a base wall positioning surface. A specific configuration for positioning the partition wall 34W and the pair of side walls 34SW by these wall positioning surfaces 40f, 41f is described later.

The partition wall 36W and the pair of side walls 36SW are arranged at intervals in a width direction of the plate portion 36B. The first and second cavities 36g1, 36g2 defined by the partition wall 36W and the pair of side walls 36SW are formed on the plate portion 36B. The partition wall 36W and the pair of side walls 36SW are examples of wall portions defining the cavities 36g1, 36g2. Particularly, the partition wall 36W is a wall partitioning between the first and second cavities 36g1, 36g2. Further, the pair of side walls 36SW are walls defining both outer sides of the cavities 36g1, 36g2.

A positioning protrusion 36gp projects on a bottom part of the cavity 36g1, 36g2. By fitting the positioning protrusion 36gp into the recess 12g of the terminal 12, the terminal 12 is positioned in the positioning protrusion 36gp.

If the terminal holder 32 is provided with a plurality of the intermediate holders 36, the terminal holder 32 can hold the terminals 12 in three or more stages in the vertical direction.

The cover holder 38 is a component spreading to such an extent as to be able to close the upper openings of the plurality of cavities 36g1, 36g2. The cover holder 38 includes locking pieces 38p lockable to locking protrusions 34r2 of the base holder 34.

A lid portion 38B is a plate-like part arranged to face tip parts of the partition wall 36W and the pair of side walls 36SW and configured to close the upper openings of the cavities 36g1, 36g2. By uniting the cover holder 38 with the intermediate holder 36, the cavities 36g1, 36g2 surrounded on four surrounding sides are formed. The intermediate holder 36 is an example of a first component including the partition wall 36W and the pair of side walls 36SW as wall portions, and the cover holder 38 is an example of a second component including a lid portion.

With the upper openings of the plurality of cavities 36g1, 36g2 closed by the lid portion 38B of the cover holder 38, the locking pieces 38p are locked to the locking protrusions 34r2 on the both sides of the base holder 34 beyond the outside of the intermediate holder 36. In this way, the cover holder 38 is held in a state united with the base holder 34 with the intermediate holder 36 arranged between the base holder 34 and the cover holder 38. In this state, the terminals 12 in the cavities 36g1, 36g2 are restricted from moving upward, and the state where the positioning protrusions 36gp are fit in the recesses 12g is maintained.

The lid portion 38B has a partition wall positioning surface 45f for positioning the partition wall 36W in a thickness direction. The lid portion 38B has side wall positioning surfaces 46f for respectively positioning the pair of side walls 36SW in the thickness direction. The partition wall positioning surface 45f and the side wall positioning surfaces 46f are examples of a wall positioning surface. A specific configuration for positioning the partition wall 36W and the pair of side walls 36SW by these wall positioning surfaces 45f, 46f is described later.

With the plurality of terminals 12 held by the terminal holder 32, the plurality of wires 16 extend out from the rear openings of the cavities 34g1, 34g2, 36g1 and 36g2.

Out of the terminal holder 32, opening edge parts, through which the wires 16 extend out from the cavities 34g1, 34g2, are exit opening edge parts 35h1, 35h2 on the side of the base holder 34. The exit opening edge part 35h1 is an edge part corresponding to the first cavity 34g1 of the base holder 34, and the first exit opening edge part 35h1 on the side of the base holder 34 located on the rear edge of the first cavity 34g1. The exit opening edge part 35h2 is an edge part corresponding to the second cavity 34g2 of the base holder 34, and the second exit opening edge part 35h2 on the side of the base holder 34 located on the rear edge of the second cavity 34g2.

Out of the terminal holder 32, opening edge parts, through which the wires 16 extend out from the cavities 36g1, 36g2, are exit opening edge parts 37h1, 37h2 on the side of the intermediate holder 36. The exit opening edge part 37h1 is an edge part corresponding to the first cavity 36g1 of the intermediate holder 36, and the first exit opening edge part 37h1 on the side of the intermediate holder 36 located on the rear edge of the first cavity 36g1. The exit opening edge part 37h2 is an edge part corresponding to the second cavity 36g2 of the intermediate holder 36, and the second exit opening edge part 37h2 on the side of the intermediate holder 36 located on the rear edge of the second cavity 36g2.

In an extension direction of the cavities 34g1, 34g2, 36g1 and 36g2, the exit opening edge parts 35h1, 35h2 of the base holder 34 are located behind and outside the exit opening edge parts 37h1, 37h2 of the intermediate holder 36.

Since the wires 16 extending out from the exit opening edge parts 37h1, 37h2 are located at an outer side of the wires 16 extending out from the exit opening edge parts 35h1, 35h2 of the base holder 34 with respect to the terminal holder 32, the wires 16 extending out from the exit opening edge parts 37h1, 37h2 are possibly more easily pulled.

The exit opening edge part 35h1, 35h2, 37h1, 37h2 has a convex curved surface 35h1a, 35h1b, 35h2a, 35h2b, 37h1a, 37h1b, 37h2a, 37h2b bent while forming a curved surface extending from the inner peripheral surface of the cavity 34g1, 34g2, 36g1, 36g2 in a direction intersecting an extension direction of the cavity 34g1, 34g2, 36g1, 36g2.

The convex curved surfaces 35h1a, 35h2a, 37h1a and 37h2a are formed on lower sides of the cavities 34g1, 34g2, 36g1 and 36g2. Thus, if the wire 16 is pulled out downward, this wire 16 is pressed against the convex curved surface 35h1a, 35h2a, 37h1a, 37h2a. In this way, a contact area of the wire 16 and the exit opening edge part 35h1, 35h2, 37h1, 37h2 is enlarged and a force acting on the wire 16 is dispersed in a wide range.

The convex curved surface 35h1b, 35h2b, 37h1b, 37h2b is formed on a side, here, on a right side, of the cavity 34g1, 34g2, 36g1, 36g2. Thus, when the wire 16 is pulled out laterally to the right, this wire 16 is pressed against the convex curved surface 35h1b, 35h2b, 37h1b, 37h2b. In this way, a contact area of the wire 16 and the exit opening edge part 35h1, 35h2, 37h1, 37h2 is enlarged and a force acting on the wire 16 is dispersed in a wide range.

To increase a contact area with the wire 16, the convex curved surface preferably has as large a radius of curvature as possible and as long an arc as possible. Accordingly, the base holder 34 of the terminal holder 32 includes thickening portions 34p. In this embodiment, the thickening portions 34p are parts formed by causing parts of the cavities 34g1, 34g2 on the side of the exit opening edge parts 35h1, 35h2 to project inwardly of the cavities 34g1, 34g2. More specifically, the thickening portions 34p are formed on parts extending toward the bottom from both side parts of the partition wall 34W and an inward facing part of the side wall 34SW on one side (right side) (see FIG. 6). The convex curved surface 35h1a, 35h1b, 35h2a, 35h2b is formed into a curved surface extending from the thickening portion 34p in an outward direction intersecting the extension direction of the cavity 34g1, 34g2.

By thickening the convex curved surfaces 35h1a, 35h1b, 35h2a and 35h2b by the thickening portions 34p, the convex curved surfaces 35h1a, 35h1b, 35h2a, 35h2b easily have a large radius of curvature and extend in a wide range. Further, it is suppressed than the terminal holder 32 is thinned in outer parts of the convex curved surfaces 35h1a, 35h1b, 35h2a and 35h2b.

Further, the front wall 34FW is formed with through holes, through which the mating terminals can pass. Each of the plurality of mating terminals is connected to the corresponding terminal 12 through the through hole.

Locking recesses 33, to which locking lances 66 are lockable, are formed in the side surfaces of the terminal holder 32. In this embodiment, a rectangular hole penetrating in an in-out direction is formed in a base end part of the locking piece 38p of the cover holder 38, and this hole is the locking recess 33. A recess, to which a locking lance is locked, may be a bottomed recess.

### Concerning Housing

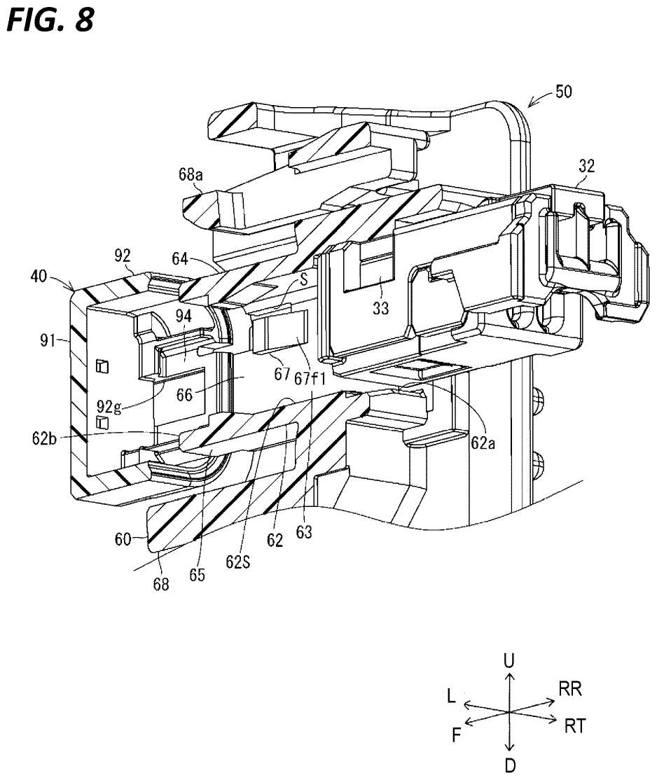

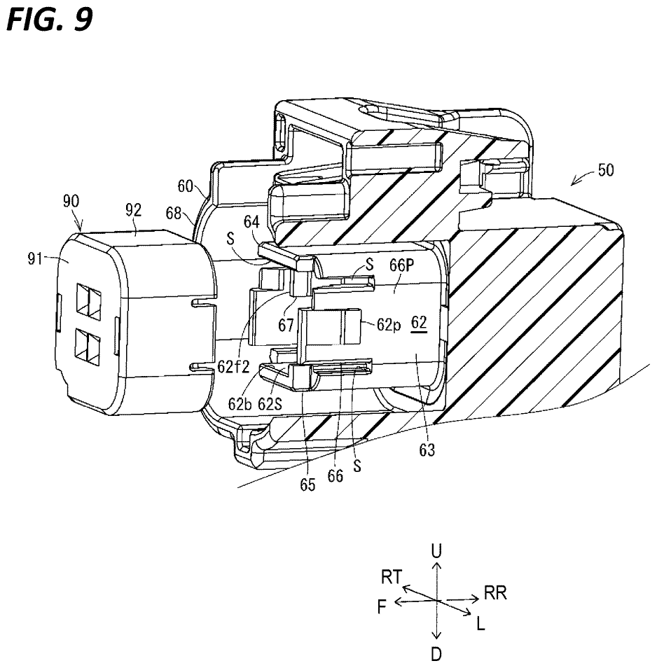

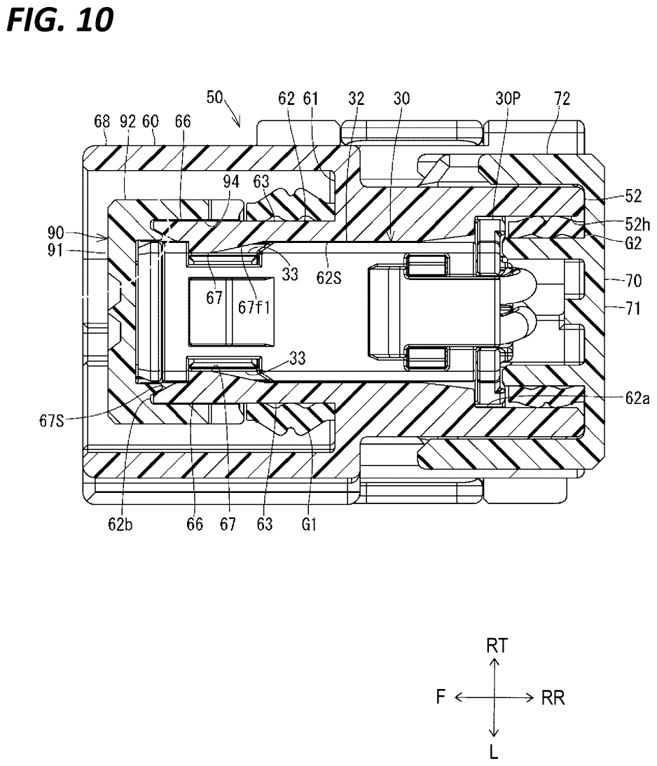

FIGS. 8 and 9 are perspective views partly in section of the housing 50. FIG. 10 is a section along X-X of FIG. 2. In FIG. 9, the terminal module 30 is drawn not as a section, but as a plan view.

As shown in FIGS. 1 to 5 and 8 to 10, the housing 50 is a molded component made of resin or the like. As described above, the housing 50 is provided with the holder holding portion 60 and the wire guiding portion 52.

The holder holding portion 60 is a part for holding the terminals 12 by holding the terminal module 30. Further, the holder holding portion 60 is a part to be connected to the mating connector while holding the terminals 12.

In this embodiment, the holder holding portion 60 is provided with an accommodation wall portion 62 and an outer wall portion 68.

The accommodation wall portion 62 is formed into a tubular shape to surround the terminal module 30. The outer wall portion 68 is formed into a tubular shape to surround a front part of the accommodation wall portion 62 while being spaced apart therefrom. In this embodiment, the accommodation wall portion 62 and the outer wall portion 68 are in the form of rectangular tubes. Here, the rectangular tube may be not only a rectangular tube with right-angle corners, but also a rectangular tube with rounded corners.

Out of the accommodation wall portion 62, a rear opening is a first opening 62a and a front opening is a second opening 62b. The terminal module 30 is arranged in the accommodation wall portion 62 with the wires 16 pulled out through the first opening 62a.

An intermediate part in an extension direction of the accommodation wall portion 62 and a rear end part of the outer wall portion 68 are connected via a coupling wall 61. That is, the coupling wall 61 is located in the intermediate part in the extension direction of the accommodation wall portion 62, and a part of the accommodation wall portion 62 forward of the coupling wall 62 forms a double wall together with the outer wall portion 68.

The front part of the accommodation wall portion 62 and the outer wall portion 68 are parts to be connected to the mating connector. A tubular part of the mating connector can enter between the front part of the accommodation wall portion 62 and the outer wall portion 68. Thus, connected parts of the terminals 12 and the mating terminals are surrounded by the accommodation wall portion 62, the tubular part of the mating connector and the outer wall portion 68. In this way, water cut-off performance and protection performance of the terminal connected parts are enhanced. Further, an annular resilient member G1 can be interposed between the accommodation wall portion 62 and the tubular part of the mating connector, whereby the water cut-off performance for the connected parts is enhanced.

The lock piece 68a to be locked to the mating connector is formed in a circumferential part (upper part) of the outer wall portion 68.

A rear part of the accommodation wall portion 62 is formed to be thicker than the front part, and extends further rearward than the rear end of the outer wall portion 68.

The holder holding portion 60 includes the locking lances 66. The locking lance 66 is formed to be resiliently deformable with a base end connected to the accommodation wall portion 62 as a fulcrum. The locking lance 66 includes a locking protrusion 67 lockable to the terminal module 30 in the accommodation wall portion 62 by projecting inwardly of the accommodation wall portion 62.

The locking lance 66 is formed to be resiliently deformable inward and outward of the accommodation wall portion 62. The locking protrusion 67 of the locking lance 66 projects inwardly of the accommodation wall portion 62 in an initial state. When the terminal module 30 is inserted into the accommodation wall portion 62, the locking lances 66 are resiliently deformed outward to allow the insertion of the terminal module 30. With the terminal module 30 accommodated in the accommodation wall portion 62, the locking lances 66 return to original positions on an inner peripheral side by resilient forces. In this way, the locking protrusions 67 can be locked to the terminal module 30.

More specifically, the front part of the accommodation wall portion 62 includes a pair of side walls 63, an upper wall 64 and a lower wall 65. The pair of side walls 63, the upper wall 64 and the lower wall 65 are connected to form a rectangular tube.

The upper and lower walls 64, 65 extend further forward than the pair of side walls 63. The plate-like locking lances 66 extend from the front edges of the pair of side walls 63.

The locking lance 66 is formed to be resiliently deformable inward and outward of the accommodation wall portion 62. In this embodiment, the locking lance 66 is in the form of a plate extending forward from the front edge of the side wall 63. Slits S are formed along a front-rear direction between the upper edge of the locking lance 66 and the upper wall 64 and between the lower edge of the locking lance 66 and the lower wall 65. Thus, the locking lance 66 can be resiliently deformed inward and outward of the accommodation wall portion 62 with a base end 66P on a rear end side connected to the side wall as a fulcrum. That is, the locking lance 66 is supported in a cantilever manner to extend toward the front side (toward the second opening 62b) opposite to a side where the wires 16 extend out from the accommodation wall portion 62 along an axial direction of the accommodation wall portion 62.

The locking protrusion 67 is a part projecting toward a terminal component accommodation space 62S, out of the locking lance 66. In this embodiment, the locking protrusion 67 partially projects in a width direction of the locking lance 66. More specifically, the locking protrusion 67 is formed in an upper part of the inner surface of the locking lance 66. The locking protrusion 67 is formed at a position to be fit into the locking recess 33 of the terminal module 30 with the terminal module 30 accommodated in the accommodation wall portion 62. The locking protrusion 67 has a guide surface 67f1 for gradually reducing a projecting dimension toward a rear side. In inserting the terminal module 30 into the accommodation wall portion 62, the terminal module 30 is pressed against the guide surface 67f1, whereby the locking protrusion 67 can be moved outward. The locking lance 66 returns to an initial shape and is fit into the locking recess 33 of the terminal module 30, whereby the terminal module 30 is restricted in position so as not to come out rearward.

The wire guiding portion 52 is a part integrally molded of resin together with the holder holding portion 60. The wire guiding portion 52 is formed into a rectangular tube shape. An upper end part of the wire guiding portion 52 is connected to a rear end side of the accommodation wall portion 62. The wire guiding portion 52 extends downward from a part connected to the rear end side of the accommodation wall portion 62. An internal space of the wire guiding portion 52 is formed to extend downward from behind the terminal module 30. The wires 16 extending out from the terminal module 30 are bent downward in an upper inner space of the wire guiding portion 52 behind the terminal module 30. The wires 16 are further led out downward through the inside of the wire guiding portion 52.

A setting opening 52h is formed in a rear part of the wire guiding portion 52.

Since the setting opening 52h is open rearward of the accommodation wall portion 62, the terminal module 30 is easily set into the accommodation wall portion 62 through this setting opening 52h. Further, the setting opening 52h is open along a wire pull-out direction of the wires 16 from behind to below the accommodation wall portion 62. Thus, during a setting operation of the terminal module 30, the wires 16 extending out from the terminal module 30 can be pulled out from the housing 50 through the setting opening 52h. Thus, a routing space for the wires 16 is easily ensured during the setting operation of the terminal module 30.

The setting opening 52h is closed by a cover member 70. The cover member 70 is a component integrally molded of resin. The cover member 70 includes a plate-like cover body 71 for closing the setting opening 52h and locking pieces 72 extending out from the cover member 70. With the setting opening 52h closed by the cover body 71, locking protrusions 50p1 on the outer side surfaces of the housing 50 are locked into locking holes of the locking pieces 72. In this way, the cover member 70 is united with the housing 50 while closing the setting opening 52h.

An annular resilient member G2 for closing a gap between the inner peripheral edge of the setting opening 52h and the cover member 70 may be arranged between the inner peripheral edge of the setting opening 52h and the cover member 70.

Out of the wire guiding portion 52, a lower end part on a side opposite to the holder holding portion 60 is formed into an entirely surrounded pull-out end part 54. The wires 16 are pulled out to outside through the wire guiding portion 52 and further through this pull-out end part 54.

A rubber plug G3 may be mounted into the pull-out end part 54 and the wires 16 may be inserted through insertion holes formed in the rubber plug G3. In this way, water intrusion along the wires 16 is suppressed. The rubber plug G3 may be pressed from outside by a pressing member 74 so as not to come out from the pull-out end part 54.

In this embodiment, an example in which the wire guiding portion 52 guides the wires 16 downward is described. The wire guiding portion 52 may guide the wires 16 in another direction. For example, the wire guiding portion 52 may guide the wires 16 straight rearward, rightward, leftward or upward. An example of a housing in which a wire guiding portion extends from a holder holding portion in a horizontal direction, more specifically in a rightward direction, is described later.

### Concerning Retainer

As shown in FIGS. 2 to 5 and 8 to 10, the retainer 90 is a member for restricting the resilient deformation of the locking lances 66. More specifically, the retainer 90 restricts outward deformation of the locking lances 66. With the locking lances 66 locked to the terminal module 30, the locking lances 66 are restricted from being deformed outward by the retainer 90. In this way, the terminal module 30 is suppressed from coming out from the accommodation wall portion 62.

The retainer 90 is a component molded of resin or the like. In this embodiment, the retainer 90 is mounted in an end part on the side of the second opening 62b on the front side of the accommodation wall portion 62.

More specifically, the retainer 90 includes a front wall 91 and a peripheral wall 92.

The front wall 91 is in the form of a plate arrangeable to close the second opening 62b. Through holes, through which the mating terminals can pass, are formed at positions corresponding to the respective terminals 12 in the front wall 91.

The peripheral wall 92 is in the form of a rectangular tube surrounding the outer peripheral surface of a front end part of the accommodation wall portion 62. Mounting recesses 92g are formed in the inner surfaces of left and right wall parts of the peripheral wall 92 (see FIG. 8). In this embodiment, mounting protrusions 62p are formed on the outward facing surfaces of the locking lances 66 (see FIG. 9). The mounting protrusions may be formed on the outer surface of the accommodation wall portion 62. If the retainer 90 is externally fit to the tip of the accommodation wall portion 62, the mounting protrusions 62p are fit into the mounting recesses 92g. In this way, the retainer 90 is mounted on the front end part of the accommodation wall portion 62 in a state where the peripheral wall 92 surrounds the outer peripheral surface of the front end part of the accommodation wall portion 62 and the front wall 91 is arranged in front of the accommodation wall portion 62.

The retainer 90 includes restricting portions 94 located outside the locking lances 66 to restrict outward movements of the locking lances 66. In this embodiment, parts, which are the inner surfaces of the left and right wall parts of the peripheral wall 92 and adjacent to the mounting recesses 92g, are the restricting portions 94. With the retainer 90 mounted on the front end part of the accommodation wall portion 62, the restricting portions 94 are arranged at positions facing the outward facing surfaces of the locking lances 66. Here, the restricting portions 94 are arranged at positions facing the outward facing surfaces of tip parts of the locking lances 66.

The restricting portion 94 and the locking lance 66 may be in contact. A gap may be formed between the restricting portion 94 and the locking lance 66 within a range that the locking of the locking protrusion 67 to the locking recess 33 cannot be released. This gap is preferably set to be as small as possible.

### Holding Structure for Terminal Module

If the terminal module 30 is inserted into the accommodation wall portion 62 from behind, the front end edge of the terminal module 30 contacts the guide surfaces 67f1 of the locking protrusions 67 and displace the locking lances 66 outward. If the front end edge of the terminal module 30 moves beyond the locking protrusions 67, the locking lances 66 return to the original shape due to their resilient forces and the locking protrusions 67 are fit into the locking recesses 33. In this way, the terminal module 30 is prevented from coming out rearward.

Further, a protrusion 30P on the rear end of the terminal module 30 contacts the rear end part of the accommodation wall portion 62, whereby a forward movement of the terminal module 30 is restricted (see FIG. 10).

Thereafter, the retainer 90 is mounted on the front end part of the accommodation wall portion 62. Then, the restricting portions 94 face the outward facing surfaces of the locking lances 66. In this way, outward movements of the tip parts of the locking lances 66 are restricted and the locking protrusions 67 hardly move outward away from the locking recesses 33.

### Concerning Positioning Structure for Wall Portions

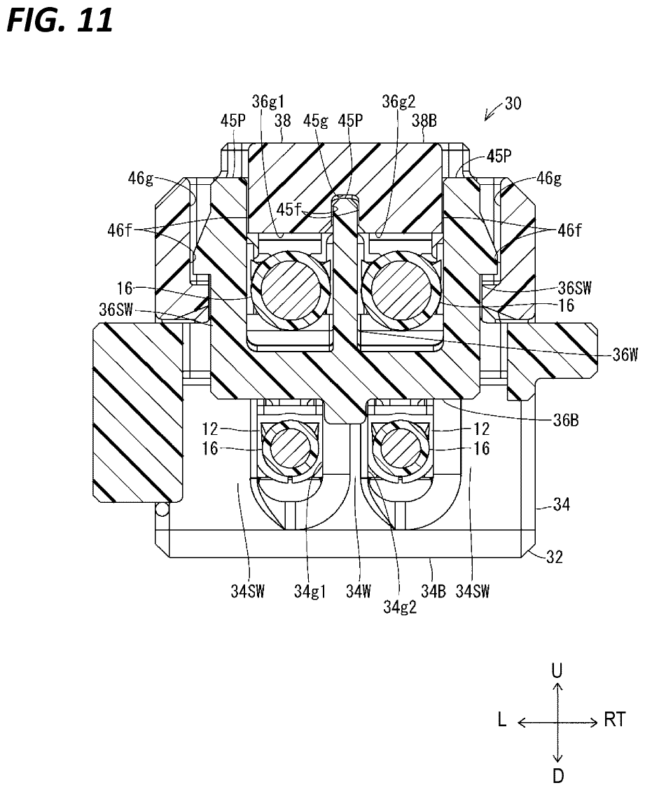

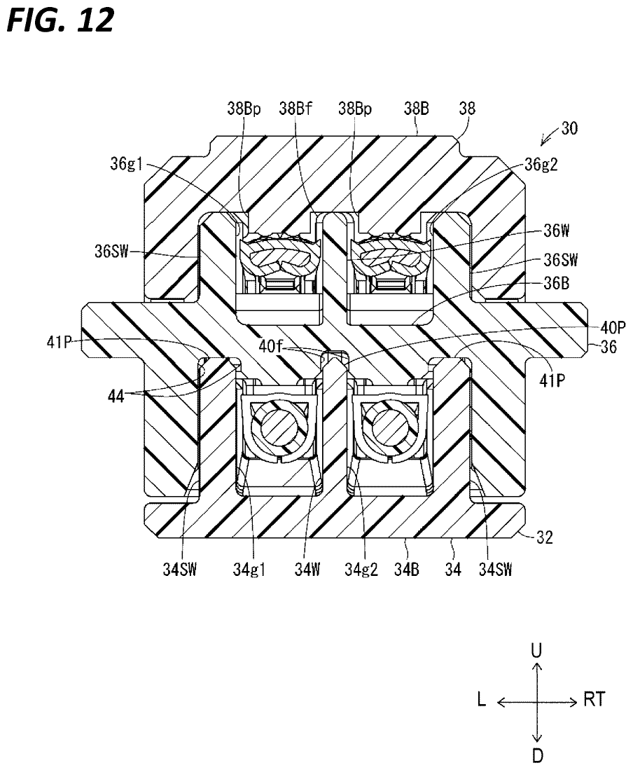

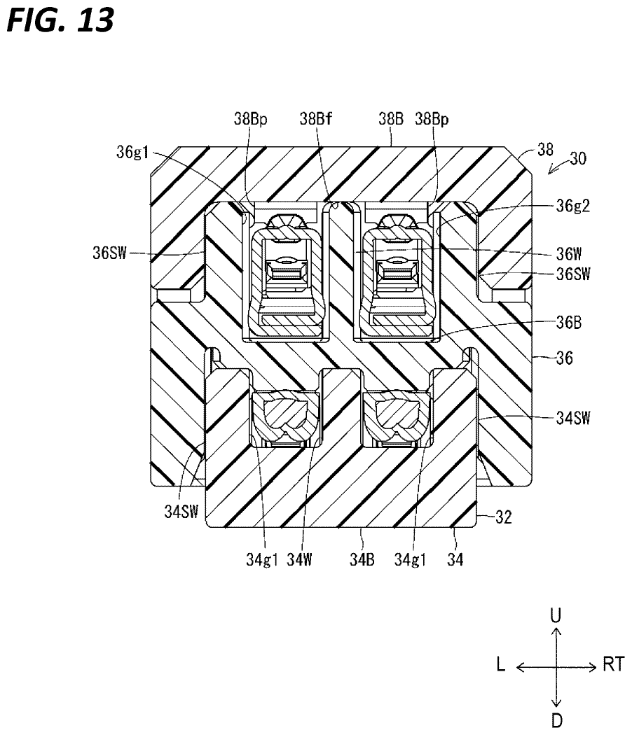

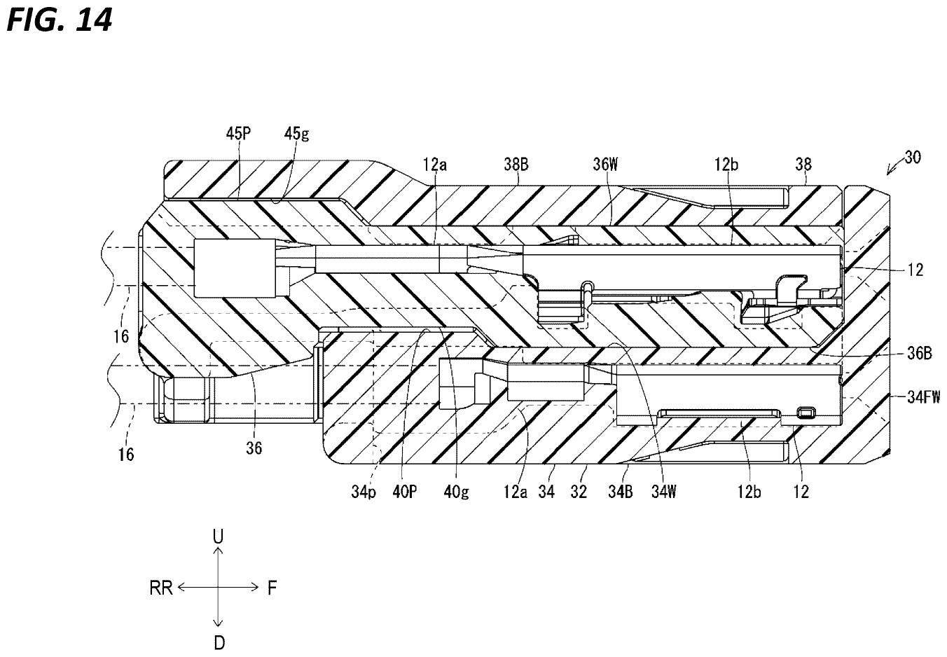

FIG. 11 is a section along XI-XI of FIG. 3. FIGS. 12 and 13 are sections on a plane parallel to and at a different position in the front-rear direction from a cross-section of FIG. 11. FIG. 11 shows a part where the partition wall 36W and the pair of side walls 36SW on the upper side are positioned. FIG. 12 shows a part where the partition wall 34W and the pair of side walls 34SW on the lower side are positioned. FIG. 13 shows a part where the partition wall 36W and the pair of side walls 36SW are not positioned by the lid portion 38B. FIG. 14 is a section along XIV-XIV of FIG. 3. In FIG. 14, side views of the terminals 12 are shown in an overlapping manner.

Mainly with reference to FIGS. 6, 7, 11 and 14, a positioning structure for the partition wall 36W and the pair of side walls 36SW is described.

The partition wall 36W is formed with a wall positioning protrusion 45P. The wall positioning protrusion 45P is a partial protrusion projecting from the tip of the partition wall 36W. The wall positioning protrusion 45P is preferably formed to be closer to an end side where the wires 16 extend out, i.e. a rear side, than a center in an extension direction of the partition wall 36W, out of the tip of the partition wall 36W.

More preferably, the wall positioning protrusion 45P is preferably located behind the terminal connecting portions 12b of the terminals 12 accommodated in the cavities 36g1, 36g2 (see FIG. 14). That is, in a side view, the wall positioning protrusion 45P is preferably arranged in a range not overlapping the terminal connecting portions 12b in the front-rear direction. In this embodiment, the wall positioning protrusion 45P is located behind the core wire crimping portions of the wire connecting portions 12a. The rear end of the wall positioning protrusion 45P is connected to the rear end edge of the partition wall 36W.

A wall positioning groove 45g is formed in a part facing the wall positioning protrusion 45P, out of a widthwise intermediate part of the lower surface of the lid portion 38B. The wall positioning groove 45g is a groove extending along the front-rear direction. The tip of the partition wall 36W, here, the wall positioning protrusion 45, is fit into the wall positioning groove 45g. The inner surfaces of the wall positioning groove 45g are wall positioning surfaces for positioning the partition wall 46W in the thickness direction thereof and, in this embodiment, are partition wall positioning surfaces. Particularly, out of the inner surfaces of the wall positioning groove 45g, a pair of left and right inner surfaces are the wall positioning surfaces 45f.

A width of the wall positioning groove 45g is set to be able to position the partition wall 36W in the thickness direction thereof according to a thickness of the wall positioning protrusion 45P. For example, the width of the wall positioning groove 45g may be equal to the thickness of the wall positioning protrusion 45P. The width of the wall positioning groove 45g may be larger than the thickness of the wall positioning protrusion 45P in a range in which a displacement of the wall positioning protrusion 45P can be restricted if the wall positioning protrusion 45P is displaced together with the partition wall 36W due to the pulling of the wire 16.

In this embodiment, the wall positioning groove 45g is formed in a part of the lid portion 38B near a rear end to correspond to the position of the wall positioning protrusion 45P. Thus, the wall positioning surfaces 45f are formed at positions for positioning an end part of the partition wall 36W on the side where the wires 16 extend out.

Each of the pair of side walls 36SW is formed with a wall positioning protrusion 46P. The wall positioning protrusion 46P is a partial protrusion projecting from the tip of the side wall 36SW. Similarly to the wall positioning protrusion 45P, the wall positioning protrusion 46P is preferably formed to be closer to an end side where the wires 16 extend out, i.e. a rear side, than a center in an extension direction of the side wall 36SW, out of the tip of the side wall 36SW, and preferably located behind the terminal connecting portions 12b.

In this embodiment, the wall positioning protrusion 46P is located behind the core wire crimping portions of the wire connecting portions 12a. The rear end of the wall positioning protrusion 46P is located in front of the rear end edge of the side wall 36SW (see FIG. 6).

The outward facing surface of the wall positioning protrusion 46P projects further than the outer surface of the side wall 36SW. Further, the outward facing surface of the wall positioning protrusion 46 has a surface inclined gradually inward toward the upper side.

A wall positioning groove 46g is formed in a part facing the wall positioning protrusion 46P, out of the lid portion 38B. The wall positioning groove 46g is a groove extending along the front-rear direction. Further, the wall positioning groove 46g penetrates through the lid portion 38B in the vertical direction. Further, the wall positioning groove 45g forms a partial recess in the inner surface of the side wall 36SW.

The tip of the side wall 36S, here, the wall positioning protrusion 46P, is fit into the wall positioning groove 46g. The inner surface of the wall positioning groove 46g is a wall positioning surface for positioning the side wall 36SW in a thickness direction thereof and, in this embodiment, is a side wall positioning surface. Particularly, out of the inner surfaces of the wall positioning groove 46g, a surface recessed with respect to the inner surface of the side wall 36S is the wall positioning surface 46f for restricting an outward movement by contacting the outward facing surface of the wall positioning protrusion 46P. Further, out of the inner surfaces of the wall positioning groove 46g, an outward facing surface formed in the lid portion 38B and facing outward is the wall positioning surface 46f for restricting an inward movement by contacting the inward facing surface of the wall positioning protrusion 46P.

Similarly to the wall positioning groove 45g, a width of the wall positioning groove 46g is set to be able to position the side wall 36SW in the thickness direction thereof according to a thickness of the wall positioning protrusion 46P.

In this embodiment, the wall positioning groove 46g is formed in a part of the lid portion 38B near a rear end according to the position of the wall positioning protrusion 46P. Thus, the wall positioning surface 46f is formed at a position for positioning an end part of the side wall 36SW on the side where the wires 16 extend out.

A groove, into which the tip part of the partition wall 36W is fit, is not formed in front of the wall positioning groove 45g in the lid portion 38B of the cover holder 38 (see FIGS. 7, 12 and 13). Thus, the lid portion 38B has a flat surface 38Bf facing the tip of the partition wall 36W and planarly spreading in the thickness direction of the partition wall 36W on a part in front of the wall positioning protrusion 45P. Pressing protrusions 38Bp for pressing the terminal connecting portions 12b in the respective cavities 36g1, 36g2 are formed at positions separated from both sides of the partition wall 36W in the lid portion 38B. A width between the inner surfaces of two pressing ribs 38Bp is larger than the width of the wall positioning groove 45g. The pressing ribs 38Bp are separated from the partition wall 36W to such an extent as not to contact the side surfaces of the partition wall 36W.

Mainly with reference to FIGS. 6, 7, 12 and 14, a positioning structure for the partition wall 34W and the pair of side walls 34SW is described.

The partition wall 34W is formed with a wall positioning protrusion 40P. The wall positioning protrusion 40P is a partial protrusion projecting from the tip of the partition wall 34W. The wall positioning protrusion 40P is preferably formed to be closer to an end side where the wires 16 extend out, i.e. a rear side, than a center in an extension direction of the partition wall 34W, out of the tip of the partition wall 34W.

More preferably, the wall positioning protrusion 40P is preferably located behind the terminal connecting portions 12b of the terminals 12 accommodated in the cavities 34g1, 34g2 (see FIG. 14). That is, in a side view, the wall positioning protrusion 40P is preferably arranged in a range not overlapping the terminal connecting portions 12b in the front-rear direction. In this embodiment, the wall positioning protrusion 40P is located behind the coating crimping portions of the wire connecting portions 12a. The rear end of the wall positioning protrusion 40P is connected to the rear end edge of the partition wall 34W.

A wall positioning groove 40g is formed in a part facing the wall positioning protrusion 40P, out of a widthwise intermediate part of the lower surface of the plate portion 36B. The wall positioning groove 40g is a groove extending along the front-rear direction. The tip of the partition wall 34W, here, the wall positioning protrusion 40P, is fit into the wall positioning groove 40g. The inner surfaces of the wall positioning groove 40g are wall positioning surfaces for positioning the partition wall 34W in the thickness direction thereof and, in this embodiment, are partition wall positioning surfaces. Particularly, out of the inner surfaces of the wall positioning groove 40g, a pair of left and right inner surfaces are the wall positioning surfaces 40f.

A relationship of a width of the wall positioning groove 40g and a thickness of the wall positioning protrusion 40P can be the same as that of the width of the wall positioning groove 45g and the thickness of the wall positioning protrusion 45P.

Each of the pair of side walls 34SW is also formed with a wall positioning protrusion 41P, similarly to the above case. Further, wall positioning grooves 41g are formed in parts of the plate portion 36B facing a pair of the wall positioning protrusions 41P, similarly to the wall positioning grooves 40g.

The thickening portions 34p projecting into the cavities 36g1, 36g2 are formed on an edge of the partition wall 34W on the rear side, which is the side where the wires 16 extend out. The wall positioning protrusion 40P is connected also to the rear end edge of the wall positioning protrusion 40P and project into the cavities 36g1, 36g2. That is, the rear end edge of the wall positioning protrusion 40P is formed to be thicker than a front part.

The wall positioning surfaces of the wall positioning groove 40g position the thickening portions 34 in the thickness direction of the partition wall 34W. More specifically, the rear end part of the wall positioning groove 40g is formed to be wider than a front part thereof. The thickening portions 34p are inserted into a wide part of the rear end part of the wall positioning groove 45g and positioned in the thickness direction of the partition wall 34W. A part of the wall positioning protrusion 40P in front of the thickening portions 34p is inserted into a narrow part in front of the rear end part of the wall positioning groove 45g and positioned in the thickness direction of the partition wall 34W.

In addition to that the wall positioning protrusion 40P is made difficult to deform by the thickening portions 34p, the thickening portions 34p themselves are positioned. Thus, as compared to the case where the thickening portions 34p are absent, the wall positioning groove 40g can more firmly position the partition wall 34W including the thickening portions 34p in the thickness direction of the partition wall 34W.

Thickening portions may be formed also on the wall positioning protrusions 41P and positioned by the wall positioning grooves.

### Concerning Wire Guiding Direction

The wire guiding portion 52 of the above housing 50 extends downward with respect to the holder holding portion 60. The terminal module 30 may be mounted into a housing for guiding the wires 16 in a direction different from the housing 50.

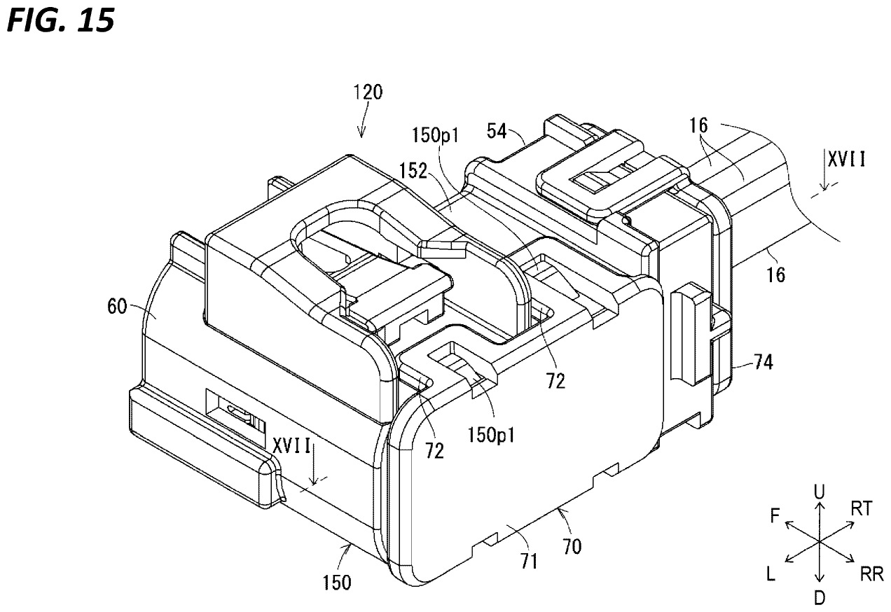

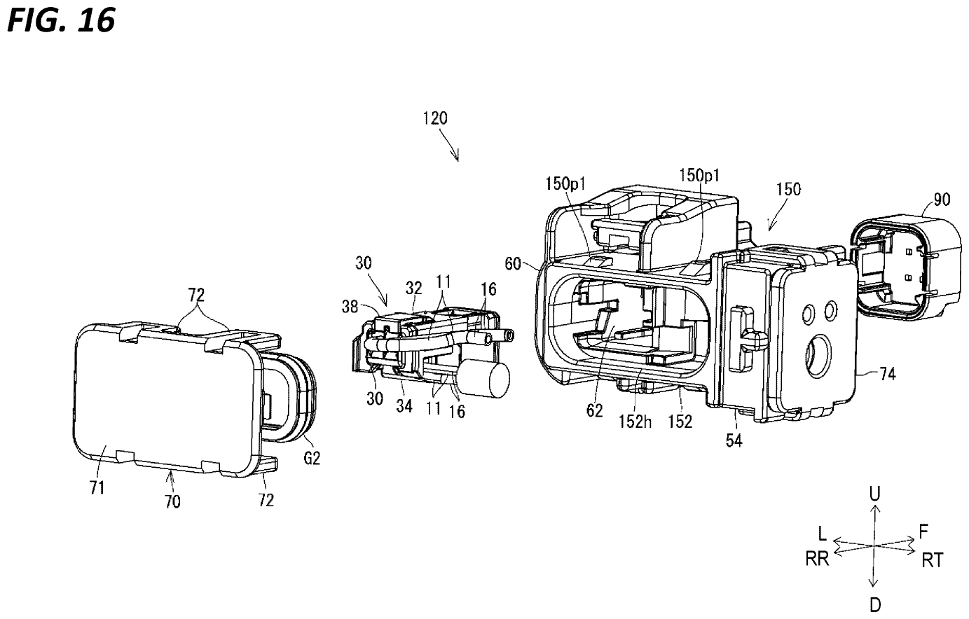

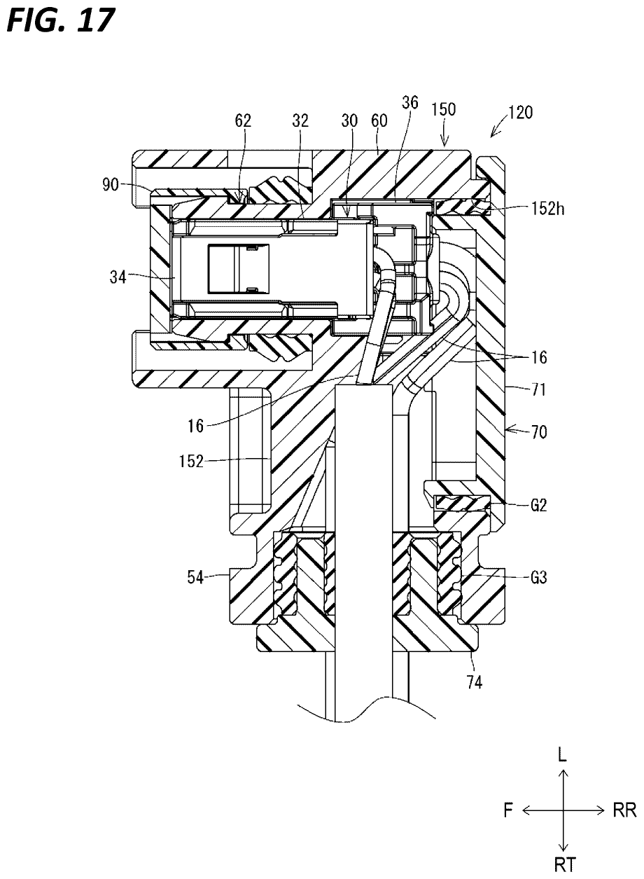

FIG. 15 is a perspective view showing a connector 120 different from the connector 20. FIG. 16 is an exploded perspective view showing the connector 120. FIG. 17 is a section along XVII-XVII of FIG. 15. This connector 120 is configured to guide wires 16 in a lateral direction with respect to a terminal module 30.

This connector 120 is described, centering on points of difference from the connector 20.

The connector 120 is provided with terminal-equipped wires 11, a terminal holder 32 and a housing 150.

The terminal-equipped wires 11 and the terminal holder 32 are the same as the terminal-equipped wires 11 and the terminal holder 32 described with respect to the connector 20. Thus, the terminal module 30 is used as a component common to the connectors 20 and 120.

A retainer 90 may also be the same as the retainer 90 described with respect to the connector 20.

The housing 150 is provided with a holder holding portion 60 and a wire guiding portion 152. The holder holding portion 60 may be a part having the same shape as the holder holding portion 60 described with respect to the connector 20.

The wire guiding portion 152 is a part integrally molded of resin together with the holder holding portion 60 and in the form of a rectangular tube, similarly to the wire guiding portion 52.

Unlike the wire guiding portion 52, the wire guiding portion 152 extends in a horizontal direction and one end part (left end part) thereof is connected to a rear end side of an accommodation wall portion 62. Thus, the wire guiding portion 152 extends in the horizontal direction from a part connected to the rear end side of the accommodation wall portion 62. An internal space of the wire guiding portion 152 is formed to extend rightward along the horizontal direction from behind the terminal module 30. The wires 16 extending out from the terminal module 30 are bent rightward in the internal space of one end part (left end part) of the wire guiding portion 152 behind the terminal module 30. The wires 16 are further led out rightward to outside through the inside of the wire guiding portion 152.

That is, the housings 50, 150 guide the wires 16 extending out from the terminal module 30 in the directions intersecting the extension direction of the terminals 12, but guiding directions are different. The housing 50 guides the wires 16 toward the base holder 34 along a stacking direction of the intermediate holder 36 on the base holder 34. The housing 150 guides the wires 16 in an arrangement direction of first cavities 34g1, 36g1 and second cavities 34g2, 36g2 (see FIG. 6).

A setting opening 152h is formed in a rear part of the wire guiding portion 152, similarly to the wire guiding portion 52.

Since the setting opening 152h is open in a rear part of the accommodation wall portion 62, the terminal module 30 is easily set into the accommodation wall portion 62 through this setting opening 152h. Further, the setting opening 152h is open along a pull-out direction of the wires 16 along the horizontal direction from behind the accommodation wall portion 62. Thus, during a setting operation of the terminal module 30, the wires 16 extending out from the terminal module 30 can be pulled out from the housing 150 through the setting opening 152h. Thus, a routing space for the wires 16 is easily ensured during the setting operation of the terminal module 30.

The setting opening 152h is closed by a cover member 70. This cover member 70 may be the same as the cover member 70 described with respect to the connector 20. With the setting opening 152h closed by a cover body 71, locking protrusions 150p1 on the outer side surfaces of the housing 150 are locked into locking holes of locking pieces 72. In this way, the cover member 70 is united with the housing 150 while closing the setting opening 152h.

An annular resilient member G2 for closing a gap between the inner peripheral edge of the setting opening 152h and the cover member 70 may be arranged between the inner peripheral edge of the setting opening 152h and the cover member 70.

Out of the wire guiding portion 152, a lower end part on a side opposite to the holder holding portion 60 is formed into an entirely surrounded pull-out end part 54, similarly to the wire guiding portion 52. The wires 16 are pulled out to outside through the wire guiding portion 152 and further through this pull-out end part 54.

A rubber plug G3 may be mounted into the pull-out end part 54 and the wires 16 may be inserted through insertion holes formed in the rubber plug G3. In this way, water intrusion along the wires 16 is suppressed. The rubber plug G3 may be pressed from outside by a pressing member 74 so as not to come out from the pull-out end part 54.

In this connector 20, the wires 16 are pulled out rightward. Thus, if the wires 16 are pulled when the terminal module 30 is mounted into the housing 150, the wires 16 possibly contact and push the rear end edges of the partition walls 34W, 36W and the side walls 34SW, 36SW rightward. Forces of the wires 16 to push the partition walls 34W, 36W and the side walls 34SW, 36SW are received by a structure for fitting the wall positioning protrusions 40P, 41P, 45P and 46P into the wall positioning grooves 40g, 41g, 45g and 46g. Thus, the partition walls 34W, 36W and the side walls 34SW, 36SW are hardly deformed and the strength of the terminal module 30 is improved. Since the strength of the terminal module 30 is improved, these forces hardly affect the terminals 12, particularly the terminal connecting portions 12b, of the terminal module 30.

### Effects, Etc.

According to the terminal module 30 and the connectors 20, 120 possibly configured as described above, the wires 16 extending out from the cavities 34g1, 34g2, 36g1 and 36g2 are possibly pressed against the partition walls 34W, 36W and the side walls 34SW, 36SW by being pulled. In this case, forces for pushing the partition walls 34W, 36W and the side walls 34SW, 36SW in the thickness directions thereof are applied to the partition walls 34W, 36W and the side walls 34SW, 36SW. Thus, the forces for pushing the partition walls 34W, 36W and the side walls 34SW, 36SW in the thickness directions thereof are received by the wall positioning surfaces 40f and the like. Therefore, the partition walls 34W, 36W and the side walls 34SW, 36SW are hardly deformed and the strength of the terminal module 30 is further improved. Further, as a result of an improvement in the strength of the terminal module 30, the ease of handling of the terminal module 30 can be improved and the manufacturing costs of the terminal module 30 and the connectors, 20, 120 can be reduced.

Further, the wall positioning surfaces 40f and the like are formed at positions for positioning the end parts of the partition walls 34W, 36W and the side walls 34SW, 36SW on the side where the wires 16 extend out. The partition walls 34W, 36W and the side walls 34SW, 36SW are easily pushed by the wires 16 on the side where the wires 16 extend out. Thus, the forces of the wires 16 to push the partition walls 34W, 36W and the side walls 34SW, 36SW can be effectively received by the wall positioning surfaces 40f and the like on the rear side.

Further, since the inner surfaces of the wall positioning grooves 40g, 41g, 45g and 46g serve as the wall positioning surfaces 40f and the like, a configuration for positioning the tips of the partition walls 34W, 36W and the side walls 34SW, 36SW is easily realized.

Further, the wall positioning protrusions 40P, 41P, 45P and 46P are formed behind the centers in the extension directions of the partition walls 34W, 36W and the side walls 34SW, 36SW, and these wall positioning protrusions 40P, 41P, 45P and 46P are fit in the wall positioning grooves 40g, 41g, 45g and 46g.

Thus, rear parts of the partition walls 34W, 36W and the side walls 34SW, 36SW on the side where the wires 16 extend out are effectively positioned by the fitting structure of the protrusions and the grooves.

Further, the lid portion 38B has the surface 38Bf facing the tip of the partition wall 36W and planarly spreading in the thickness direction of the partition wall 36W on the side in front of the wall positioning protrusion 45P. Thus, even if the partition wall 36W is deformed in the thickness direction, this deformation hardly affects the front part of the cover holder 38. In this way, an external force is hardly applied to the tip parts of the terminals 12.

Particularly, if the wall positioning protrusions 40P, 41P, 45P and 46P are located behind the terminal connecting portions 12b, the partition walls 34W, 36W and the side walls 34SW, 36SW can be positioned behind the terminal connecting portions 12b. Thus, an external force is hardly applied to the tip parts of the terminals 12.

Further, the partition wall 34W includes the thickening portions 34p on the rear end edge, and the wall positioning groove 45g positions the thickening portions 34p in the thickness direction of the partition wall 34W. A force given when the wires 16 are pulled is thought to most strongly act on the rear end edge part of the partition wall 34W. If the thickening portions 34p located on the rear end edge of the partition wall 34W are positioned by the wall positioning groove 45g, this force is effectively received.

Further, each of the partition walls 34W, 36W and the side walls 34SW, 36SW is formed with the positioning protrusion 40P, 41P, 45P, 46P and each positioning protrusion 40P, 41P, 45P, 46P is positioned by the wall positioning groove 40g, 41g, 45g, 46g. Thus, regardless of which of the wires 16 extending out from the plurality of cavities 34g1, 34g2, 36g1 and 36g2 is pulled, the partition wall 34W, 36W or the side wall 34SW, 36SW can be positioned to withstand this pulling force.

The exit opening edge parts 37h1, 37h2 of the upper cavities 36g1, 36g2 are located at an outer side of the exit opening edge parts 35h1, 35h2 of the lower cavities 34g1, 34g2. There is a possibility that the wires 16 extending out from the upper cavities 36g1, 36g2 on the outer side are easily pulled with a strong force. Accordingly, the pulling forces of the wires 16 can be effectively received by positioning the partition wall 36W and the side walls 36SW defining the cavities 36g1, 36g2.

Further, since the base holder 34 as the first component has the wall positioning surfaces 40f, 41f as the base wall positioning surfaces for positioning the partition wall 34W and the side walls 34SW as the base wall portions, the partition wall 34W and the side walls 34SW defining the cavities 34g1, 34g2, which are base cavities, can also be positioned.

Further, by applying the terminal module 30 to the connector 20, 120 including the housing 50, 150, even if a force is applied to the partition wall 34W and the side walls 34SW by pulling the wires 16 when the terminal module 30 is mounted into the housing 50, 150, this force is effectively received by the wall positioning surfaces 40f, 41f, 45f and 46f.

### Modifications

Note that, in the above embodiment, the tip in the extension direction of the partition wall or the side wall may be entirely fit into the groove formed in the lid portion or the plate portion.

Further, a first protrusion and a second protrusion extending from the plate portion or the lid portion toward the cavities may be formed at positions for sandwiching the wall portion and the wall portion may be positioned in the thickness direction by sandwiching a tip part of the wall portion between the first and second protrusions. In this case, mutually facing surfaces of the first and second protrusions can be wall positioning surfaces.

Note that the respective configurations described in the above embodiment and each modification can be approximately combined without contradicting each other.

### LIST OF REFERENCE NUMERALS

11 terminal-equipped wire
12 terminal
12a wire connecting portion
12b terminal connecting portion
12g recess
16 wire
20, 120 connector
30 terminal module
30P protrusion
32 terminal holder
33 locking recess
34 base holder
34B bottom portion
34FW front wall
34SW side wall (base wall portion, wall portion)
34W partition wall (base wall portion, wall portion)
34g1 first cavity (base cavity)
34g2 second cavity (base cavity)
34gp, 36gp positioning protrusion
34p thickening portion
34r1, 34r2 locking protrusion
35h1, 37h1 first exit opening edge part (exit opening edge part)
35h2, 37h2 second exit opening edge part (exit opening edge part)
35h1a, 35h1b, 35h2a, 35h2b, 37h1a, 37h1b, 37h2a, 37h2b convex curved surface
36 intermediate holder (first component)
36B plate portion
36p, 38p locking piece
36SW side wall (wall portion)
36W partition wall (wall portion)
36g1 first cavity (base cavity)
36g2 second cavity (base cavity)
38 cover holder (second component)
38B lid portion
38Bf flat surface (surface)
38Bp pressing protrusion
40P wall positioning protrusion
40f partition wall positioning surface (wall positioning surface, base wall positioning surface)
40g wall positioning groove
41P wall positioning protrusion
41f side wall positioning surface (wall positioning surface, base wall positioning surface)
41g wall positioning groove
45P wall positioning protrusion
45f partition wall positioning surface (wall positioning surface)
45g wall positioning groove
46P wall positioning protrusion
46f side wall positioning surface (wall positioning surface)
46g wall positioning groove
50, 150 housing
50p1, 150p1 locking protrusion
52, 152 wire guiding portion
52h, 152h setting opening
54 pull-out end part
60 holder holding portion
61 coupling wall
62 accommodation wall portion
62S terminal component accommodation space
62a first opening
62b second opening
62p mounting protrusion
63 side wall
64 upper wall
65 lower wall
66 locking lance
66P base end
67 locking protrusion
67f1 guide surface
68 outer wall portion
68a lock piece
70 cover member
71 cover body
72 locking piece
74 pressing member
90 retainer
91 front wall
92 peripheral wall
92g mounting recess
94 restricting portion
G1 annular resilient member
G2 annular resilient member
G3 rubber plug
S slit

1. A terminal module for accommodating a terminal, comprising:
a terminal-equipped wire including a wire and the terminal mounted on an end part of the wire; and
a terminal holder including a cavity for holding the terminal, the wire extending out from an opening of the cavity,
the terminal holder including a first component and a second component forming the cavity by being united with the first component,
the first component including a wall portion defining the cavity and the second component including a lid portion facing a tip part of the wall portion, and
the lid portion having a wall positioning surface for positioning the wall portion in a thickness direction of the wall portion.

2. The terminal module of claim 1, wherein the wall positioning surface is formed at a position for positioning an end part of the wall portion on a side where the wire extends out.

3. The terminal module of claim 1, wherein:
the lid portion includes a wall positioning groove, a tip of the wall portion being fit into the wall positioning groove, and
an inner surface of the wall positioning groove is the wall positioning surface.

4. The terminal module of claim 3, wherein:
a wall positioning protrusion is formed on an end side closer to the side where the wire extends out than a center in an extension direction of the wall portion, out of the tip of the wall portion, and
the wall positioning protrusion is fit in the wall positioning groove.

5. The terminal module of claim 4, wherein the lid portion has a surface facing the tip of the wall portion and planarly spreading in the thickness direction of the wall portion on a side opposite to the wall positioning protrusion in an extension direction of the wire.

6. The terminal module of claim 5, wherein:
the terminal includes a terminal connecting portion and a wire connecting portion to be connected to the wire, and
the wall positioning protrusion is located closer to an extension direction side of the wire than the terminal connecting portion.

7. The terminal module of claim 1, wherein:
the wall portion includes a thickening portion projecting into the cavity on an edge on an extension direction side of the wire, and
the wall positioning surface positions the thickening portion in the thickness direction of the wall portion.

8. The terminal module of claim 1, wherein:
the wall portion includes a pair of side walls and a partition wall located between the pair of side walls, and
the wall positioning surface includes a pair of side wall positioning surfaces for positioning each of the pair of side walls in a thickness direction of each side wall and a partition wall positioning surface for positioning the partition wall in a thickness direction of the partition wall.

9. The terminal module of claim 1, wherein:
the terminal holder further includes a base holder having a base wall portion,
a base cavity defined by the base wall portion is formed by overlapping the first component on the base holder, and
an exit opening edge part for the wire, out of the cavity, is located at an outer side of an exit opening edge part for the wire, out of the base cavity.

10. The terminal module of claim 9, wherein the first component has a base wall positioning surface for positioning the base wall portion in a thickness direction of the base wall portion.

11. A connector, comprising:
the terminal module of claim 1; and
a housing including a holder holding portion for holding the terminal holder and a wire guiding portion for guiding the wire extending out from the holder holding portion.
